(19) United States
(12) Patent Application Publication
(10) Pub. No.: US 2025/0322819 A1
(43) Pub. Date: Oct. 16, 2025

(54) Face alignment virtual piano system

(71) Applicant: Ji-Hong Alex Wu, Ottawa (CA)

(72) Inventor: Ji-Hong Alex Wu, Ottawa (CA)

(73) Assignee: Ji-Hong Alex Wu, Ottawa, ON (CA)

(21) Appl. No.: 18/634,989

(22) Filed: Apr. 14, 2024

(51) Int. Cl. G10H 5/00; G06F 3/01

(52) U.S. Cl. CPC G10H 5/007; G06F 3/012; G10H 2220/455

(57) ABSTRACT

The present invention relates to a face alignment virtual piano system using computer vision technology. Traditionally, projector-based virtual pianos are centered on the projection, this limits the size of virtual pianos. The system circumvents this issue by utilizing facial landmark tracking to accurately and dynamically adjust the virtual keyboard's alignment based on the user's face position. In doing so the position of the keyboard is no longer fixed to the position of the projection, but rather it is determined by the user's position. This not only significantly enhances the freedom of movement of the user, but also allows for the possibility of full 88-key pianos.

### TECHNICAL FIELD

The present invention relates to the field of human-computer interaction and, in particular, to a method for aligning augmented reality (AR) virtual pianos to the user's face.

### BACKGROUND

The field of human-computer interaction (HCI) is a field of research focusing on the interaction between people (users) and computers. Input devices for visual-based HCI, specifically those that use body movement tracking visual-based HCI, run into issues with accuracy while also limiting the size of virtual pianos. My face alignment system mitigates these problems by determining the position of keys based on the position of the user's face in a camera feed instead of a fixed keyboard location.

### SUMMARY OF THE INVENTION

The disclosed invention is a face alignment virtual piano system using camera-based computer vision (CV) technology, designed to overcome the limitations of current virtual piano systems, such as that they need to be projected onto a surface, and that they have a limited key range. The system uses facial landmark detection to dynamically update the position of the keyboard by aligning it with the user's face captured by the camera.

This approach eliminates the need for the virtual piano to be projected and fixed onto a surface, allowing users to move freely and expanding the range of virtual pianos.

The system mainly comprises of a computer system loaded with a program that tracks hand, fingers, and facial landmark positions through a live camera feed, and then uses these inputs to determine keypresses and dynamically move the virtual piano keyboard to align with the user's position.

By freeing the virtual piano from a projection on a surface and tying it directly to the position of the user's face, this solution enhances the user experience by granting freedom of movement, and a wider range of keys. With this system, users can seamlessly navigate a full 88-key keyboard as the whole keyboard.

### BRIEF DESCRIPTION OF THE DRAWINGS

FIG. 1 shows the elements of the face alignment virtual piano system.

FIG. 2 illustrates a flowchart for the working process of the face alignment virtual piano system.

FIG. 3 shows the view from the position of the camera.

FIG. 4 illustrates the implementation for the face alignment virtual piano system.

FIG. 5 shows a side view of the face alignment virtual piano system.

### DETAILED DESCRIPTION OF EMBODIMENTS

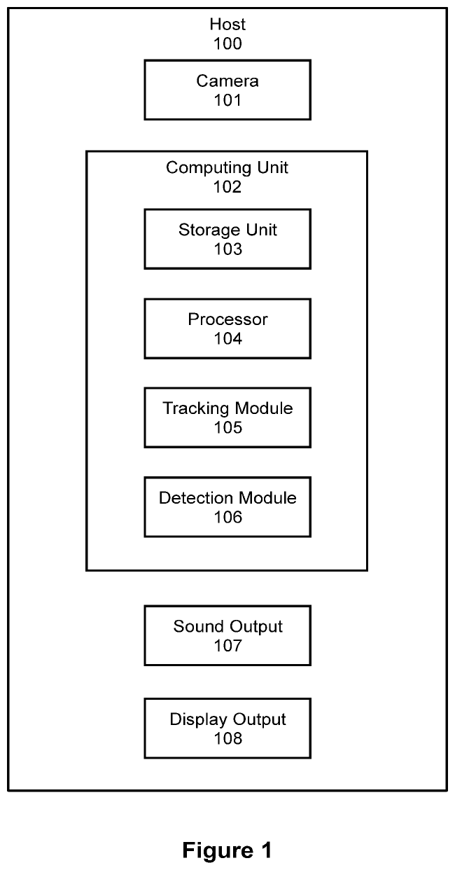

FIG. 1 shows the elements of the face alignment virtual piano system. The host 100 includes a camera 101, a computing unit 102, a sound output unit 107, and a display output unit 108. The computing unit 102 contains a storage unit 103, a processor 104, a tracking module 105, and a detection module 106.

The tracking module 105 uses landmark detection techniques to determine the positions of the user's face and fingers.

The detection module 106 is used for calculating the position of the middle C key and detecting all fingers' movements by comparing the positions of each finger with the results obtained from tracking module 105.

The processor 104 is used for data calculation and process controlling for the tracking module 105 and the detection module 106, processing and sending the sound signals to sound output unit 107, as well as processing and sending the captured camera feed to display output unit 108.

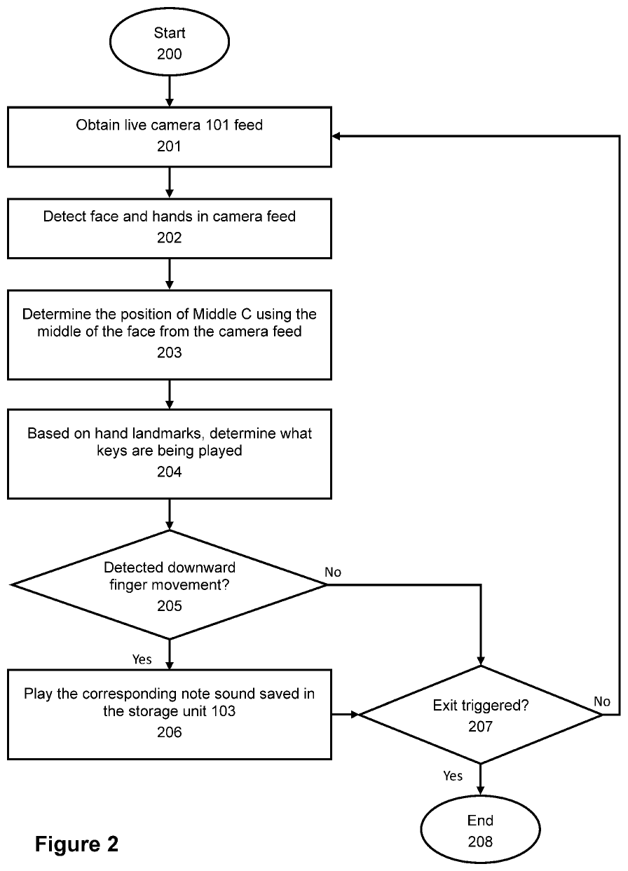

FIG. 2 illustrates a process flowchart 200 for the face alignment virtual piano system. The process 200 starts by obtaining live camera data 201, in which camera 101 captures live images of the user's face and fingers and sends them to the computing unit 102.

In step 202, images captured in step 201 that are sent to the computing unit 102, are analyzed by the tracking module 105. The user's face and hands are detected.

In step 203, the detection module 106 calculates the position of the middle C key using the current horizontal coordinate of the user's face obtained in step 202.

In step 204, the detection module 106 determines what notes sound should be played, based on the current relative distance of certain finger landmarks obtained in step 202, to the middle C key obtained in step 203.

In step 205, a downward finger motion is detected by comparing the difference between the vertical positions from the last frame to the present frame to determine their velocities and direction using the detection module 106.

In step 205, if a downward finger motion is detected, then execute step 206, if not execute step 207.

In step 206, the corresponding notes sounds, which are determined in step 204, are sent to the sound output 107 to be played.

In step 207, detect whether the exit key is pressed, if so, end the program, if not, back to step 201. The exit key is defined as any input the user can activate to end the program.

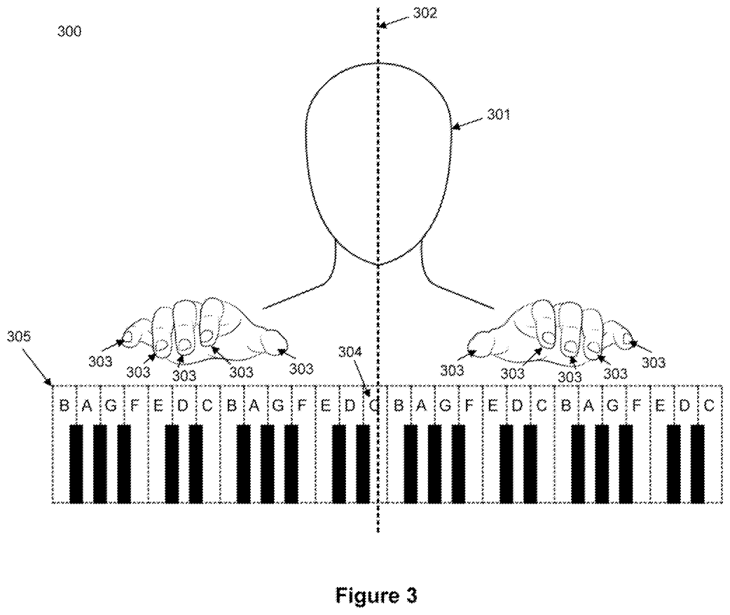

FIG. 3 shows the view from the position of the camera. The view 300 includes user 301, the user's facial midline 302, the finger landmarks 303, the virtual middle C key 304, and the virtual keyboard 305. Note that the user's facial midline 302, the virtual middle C key 304 and the virtual keyboard 305 do not physically exist and are solely for clarity purposes.

The determined position of the user's facial midline 302 decides the location of the virtual middle C key 304. The position and size of the keys on the virtual keyboard 305 are generated based on the perceived width of certain finger landmarks 303 from the perspective of the camera 101. The corresponding keys are determined and calculated based on the relative distance of certain finger landmarks to the user's facial midline 302. By referencing the position of the user's facial midline 302, the user can adjust the hand position to play the expected keys. Note that the user's facial midline 302, the virtual middle C key 304 and the virtual keyboard 305 do not physically exist and are solely for clarity purposes.

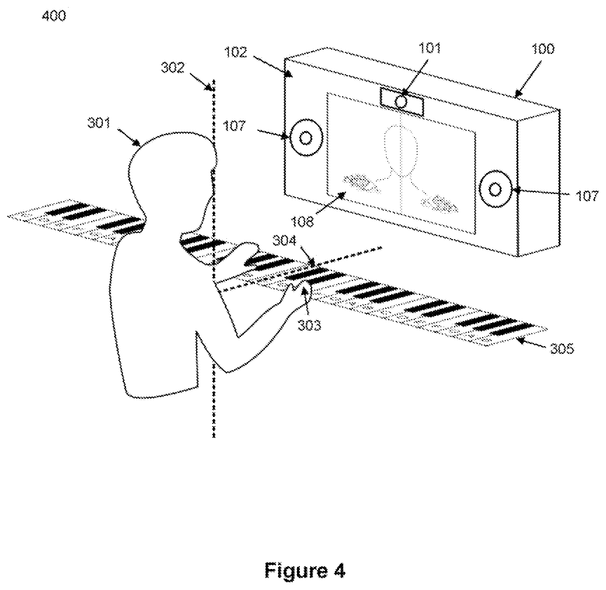

FIG. 4 shows an implementation of the entire system. The host 100 includes a camera 101, a computing unit 102, a sound output unit 107, and a display output unit 108. The user stays in the front of the host 100. The system will generate the virtual keyboard 305 based on the detected positions of the user's facial midline 302 and the fingers landmarks 303, calculated by the computing unit 102, with the live images of the user's face and fingers captured by the camera 101. The live images of the user's face and fingers are captured by the camera 101 and will be shown on the display output unit 108 with visual landmarks overlayed on top of the captured images. Note that 302, 304 and 305 do not physically exist and are solely for clarity purposes.

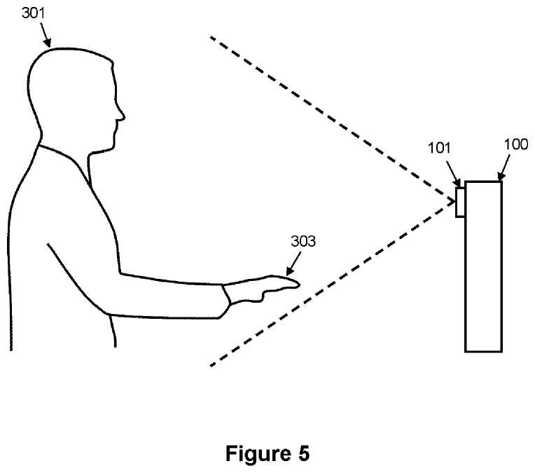

FIG. 5 shows the side view of the system. It demonstrates the relationship between user 301, user's fingers 303, camera 101, and host 100.

What is claimed is:

1. An apparatus comprising:
a) an on-body camera to capture the user's face and user's fingers;
b) a display output to show the user's face and user's fingers real-time movement;
c) at least one processor to detect movement of the user's fingers, measure the relative distance between the user's facial midline and fingers to calculate the corresponding keys, and to generate the piano sounds based on the tone of the corresponding keys;
d) a program included a tracking module and a detection module;
e) an on-body storage unit to store the piano sound files for all 88 keys, and
f) an on-body sound output unit to play the sound.

2. The apparatus of claim 1 wherein the program included the tracking module captures the real-time data of the user's face and the user's fingers positions captured by the camera.

3. The apparatus of claim 1 wherein the program included the detection module processes the real-time data of the user's face and the user's fingers positions from the camera to calculate which keys the user are currently playing in the air, then to play the sound of the corresponding keys.

4. The apparatus of claim 1 wherein the program determines user's facial midline by analyzing live camera feed using facial recognition techniques.

5. The apparatus of claim 4 wherein the position of the middle C key is determined by the location of the user's facial midline.

6. The apparatus of claim 5 wherein the position of the middle C key is continuously determined in order to calculate the position of the other keys.

7. The apparatus of claim 1 wherein the program detects downwards fingers motion by determining the velocities of the user's fingers.

8. The apparatus of claim 7 wherein the program calculates the relative distance between the position of the user's facial midline, and the position of the user's fingers.

9. The apparatus of claim 1 wherein the program uses the ratio of the measured relative distance between the user's facial midline and the position of the fingers, and a predefined white key and black key sizes in order to calculate which keys the user is currently playing.

10. The apparatus of claim 1 wherein the program retrieves the note sounds from an array corresponding to the calculated keys.

11. The apparatus of claim 10 wherein an array contains the path of 88 key sound files, which are saved in the storage unit.
